(19) United States
(12) Patent Application Publication
(10) Pub. No.: US 2026/0125835 A1
(43) Pub. Date: May 7, 2026

(54) APPARATUS FOR THE CONTINUOUS PRODUCTION OF A MATTRESS COMPRISING AGGLOMERATED MINERAL FIBRES

(71) Applicant: STM Technologies S.R.L., Milano (IT)

(72) Inventors: Marco La Greca, Calvenzano (BG) (IT); Roberto Massini, Calvenzano (BG) (IT)

(73) Assignee: STM Technologies S.R.L., Milano (IT)

(21) Appl. No.: 19/118,930

(22) PCT Filed: Nov. 15, 2023
(86) PCT No.: PCT/EP2023/081921

§ 371 Date: Apr. 7, 2025

(30) Foreign Application Priority Data
Nov. 18, 2022 (IT) 102022000023829

(51) Int. Cl. D04H 17/12; D04H 1/4226

(52) U.S. Cl. CPC D04H 17/12; D04H 1/4226; D10B 2505/08

(57) ABSTRACT

An apparatus (100) for the continuous production of a mattress (14) comprising agglomerated mineral fibres is described, the apparatus comprising a mineral fibre receiving or forming chamber (2), an accumulator conveyor (3) arranged below the receiving or forming chamber (2) and comprising adjacent drums (4) provided with perforated or gas-permeable circumferential surfaces (5) for receiving and accumulating the fibres to form a mattress (14) comprising mineral fibres between the drums (4), a gas extraction device (6) in fluid communication with the perforated or gas-permeable circumferential surfaces (5) of the drums (4) and a lower space (10) between the drums (4) for unloading the mattress (14) comprising mineral fibres formed between the drums (4), the apparatus (100) being characterized in that said drums (4) are movable along a displacement axis (Y) perpendicular to an axis of rotation (X) of said drums (4) between a first end-stroke position in which the drums (4) are in a position of maximum distance from each other and a second end-stroke position in which the drums (4) are in a position of maximum proximity to each other.

### FIELD OF APPLICATION

In its more general aspect, the present invention relates to the production of thermally insulating mattresses comprising agglomerated mineral fibres (unwoven), such as for example glass fibres or rock wool fibres.

In particular, the present invention relates to an apparatus for the continuous production of a mattress of agglomerated mineral fibres comprising a mineral fibre receiving or forming chamber, an accumulator conveyor arranged below the receiving or forming chamber and comprising adjacent drums provided with perforated or gas-permeable surfaces for receiving and accumulating the fibres to form a mattress of agglomerated mineral fibres between the drums, a gas extraction device in fluid communication with the perforated or gas-permeable surfaces of the drums and a lower space between the drums for unloading the mattress formed between the drums.

The present invention represents in particular an improvement of the prior art for receiving (collecting) so-called insulating mineral fibres containing a binder at the liquid state and for separating the gases and induced air coming from the fiberization machines in order to produce a mattress with said mineral fibres.

### PRIOR ART

As it is known in the art, the production of mattresses comprising agglomerated mineral fibres, such as glass fibres, involves the separation of the fibres produced by the fibre forming machines (fiberization machines) from the gases and induced air generated by the burners of said machines and the collection and forming (accumulation) of the separated fibres to form a felt, substantially in the form of a mattress, containing agglomerated mineral fibres.

In order to perform said operations, it is well known to use apparatuses comprising a receiving or forming chamber intended to be fed above by a flow comprising mineral fibres, gases and induced air coming from the fiberization machines, an accumulator conveyor arranged below the fibre receiving or forming chamber and comprising adjacent drums provided with perforated or gas-permeable surfaces for receiving and accumulating the fibres to form a mattress comprising agglomerated mineral fibres between the drums, a gas extraction device in communication with the perforated or gas-permeable surfaces of the drums and a lower space between the drums for unloading the mattress comprising agglomerated mineral fibres formed between the drums.

In particular, according to known methods, the flow comprising gases, induced air and mineral fibres impregnated with a binder mixture (resin) outputted from the fiberization machines is introduced in the fibre receiving or forming chamber and directed towards the gas-permeable or perforated surfaces of the drums arranged below the receiving or forming chamber. These surfaces are gas-permeable or they have holes having such dimensions as to allow gases to pass therethrough but not mineral fibres to pass. They are subject to the suction effect exerted by the gas extraction device and they operate as a kind of filter allowing fibres to be accumulated thereon to form a mattress comprising mineral fibres while the sucked gas passing therethrough is released outside. The so-formed mattress comprising mineral fibres is thus unloaded through the lower space formed between the drums which is suitably predetermined depending on the desired thickness for the mattress.

Conventionally, the fibre receiving or forming chamber comprises an upper part having first vertical walls longitudinally extended in the direction of the axis of rotation of the drums and second vertical walls transversally extended with respect to the axis of rotation of the drums, such first and second walls laterally delimiting the receiving or forming chamber, and a lower element equipped with recesses in the form of arcs of a circle below which the drums are housed.

The first vertical walls and the second vertical walls of the chamber usually consist of rotating carpets or belts, usually made of polyvinylchloride (PVC), whose outward-facing part is in contact with cleaning means, for example scraping blades, which arrange to keep the surfaces of these walls clean from clots of fibres impregnated with the binder mixture which otherwise would form thereon if the walls were fixed and which could fall between the drums damaging the quality of the produced mattress of mineral fibres.

Moreover, the first vertical walls have a greater height since they laterally overlap the lower element ending below in a tangential juxtaposition to the gas-permeable or perforated surface of the drums while the second vertical walls of the chute end below above the lower element and are movable above the drums along the direction of the axis of rotation thereof distancing from or approaching each other so as to adjust the width of the fibre receiving or forming chamber (i.e. the chamber dimension in the direction of the axis of rotation of the drums) depending on the width or transversal width of the mattress of mineral fibres which is to be obtained.

An improving apparatus for the continuous production of a mattress of agglomerated mineral fibres is described in the patent application WO 2022/074106 in the name of the Applicant. In said apparatus, each drum comprises a first half-drum and a second half-drum telescopically connected to each other and movable along an axis of rotation between a first end-stroke position in which the first half-drum and the second half-drum are juxtaposed or in contact with each other and a second end-stroke position in which the first half-drum and the second half-drum are spaced apart from each other at a predetermined maximum distance, a gas-permeable or perforated circumferential band being further provided, which overlaps at least one of said first half-drum and said second half-drum at opposite end portions of said half-drums.

Said apparatus advantageously allows the use of the fixed lower element to be eliminated thereby reducing the formation of clots of impregnated fibres inside the receiving or forming chamber while maintaining the capability to adjust the width or amplitude of the mattress of mineral fibres obtained with the apparatus according to the production requirements.

Although the above-described apparatus is satisfactory from the functional point of view, it has the limitation that the drums are arranged at a fixed distance which can involve drawbacks in the production of the mattress of fibres.

In fact, the distance between the drums helps to determine the pressure to which the mineral fibres in the mattress being formed between the rollers are subjected and which allows the mattress of mineral fibres to be felted, i.e. made compact. Said pressure is greater the greater the weight per square meter (weight/m²) of the mineral fibres is in the mattress being formed and which determines the final compactness of the mattress of mineral fibres.

If on the one hand the pressure exerted by the drums on the mattress of fibres being formed is therefore required to couple the mineral fibres and to obtain a material of mineral fibres having an appropriate compactness, on the other hand it is noted that if said pressure was too high, the fibres could break while if it was too low the final mattress of mineral fibres could be not very compact. In both cases, this involves an unsatisfactory product to be obtained, for example, since it is damaged and/or not compliant with the required features, for example in terms of mechanical resistance features.

The main object of the present invention is therefore to provide an apparatus for the continuous production of a mattress comprising agglomerated mineral fibres having such structural features as to allow to adjust the pressure exerted by the drums on the mattress of fibres being formed and hence the compactness and/or thickness of the produced mattress so as to have a product with appropriate features according to the requirements and to overcome the drawbacks mentioned above with reference to the prior art.

Another object of the present invention is to provide an apparatus as above which has not structural complications so as to make the manufacture of the products obtained therefrom simple and economical.

### SUMMARY OF THE INVENTION

These objects are achieved by an apparatus for the continuous production of a mattress comprising agglomerated mineral fibres comprising a mineral fibre receiving or forming chamber, an accumulator conveyor arranged below the receiving or forming chamber and comprising adjacent drums provided with perforated or gas-permeable circumferential surfaces for receiving and accumulating the fibres to form a mattress comprising mineral fibres between the drums, a gas extraction device in fluid communication with the perforated or gas-permeable surfaces of the drums and a lower space between the drums for unloading the mattress comprising mineral fibres formed between the drums, the apparatus being characterized in that said drums are movable along a displacement axis substantially perpendicular to an axis of rotation of said drums between a first end-stroke position in which the drums are in a position of maximum distance from each other and a second end-stroke position in which the drums are in a position of minimum proximity to each other.

In an embodiment, the fibre receiving or forming chamber comprises first vertical walls longitudinally extended in the direction of the axis of rotation of the drums and ending each below in a tangential juxtaposition to the gas-permeable or perforated circumferential surfaces of a respective drum, and second vertical walls transversally extended with respect to the axis of rotation of said drums and ending each below in a lateral juxtaposition to a respective drum.

In an embodiment, the apparatus further comprises lower carriages sliding along said displacement axis to which respective drums are integrally connected, and means for adjusting the translational movement along the displacement axis of each lower carriage connected to a respective drum.

Preferably, said means for adjusting the translational movement of a lower carriage comprise at least one rotating screw connected to said lower carriage and motorized means adapted to impart a rotational movement to said at least one screw so as to adjust the advancement of said lower carriage and of the drum integral with it along the displacement axis in approaching or distancing from the opposite drum.

In an embodiment, the distance between the circumferential surfaces of the drums between the position of maximum proximity and the position of maximum distance thereof is comprised between 10 mm and 400 mm, preferably between 40 mm and 300 mm.

In an embodiment, the above first vertical walls of the receiving or forming chamber are movable in the direction of the height of the fibre receiving or forming chamber along a vertical axis perpendicular to the axis of rotation of the drums, so as to maintain the tangential juxtaposition of the lower end of the first vertical walls to the perforated circumferential surface of one of the respective drums, depending on the mutual positioning of the drums along the displacement axis.

In an embodiment, the above drums comprise each a first half-drum and a second half-drum connected to each other, in particular telescopically, and movable along the axis of rotation between a first end-stroke position in which the first half-drum and the second half-drum are juxtaposed or in contact with each other, and a second end-stroke position in which the first half-drum and the second half-drum are spaced apart from each other at a predetermined maximum distance along the direction of the axis of rotation of the drums, a gas-permeable or perforated circumferential band being further provided, which overlaps at least one of said first half-drum and said second half-drum at opposite end portions of said half-drums.

In an embodiment, the apparatus further comprises upper carriages sliding along said axis of rotation to which respective half-drums of a drum are integrally connected, each upper carriage being slidable along a pair of opposite guides extended along the axis of rotation of the drums and fixed on a respective lower carriage, and means for adjusting the translational movement along the axis of rotation of each upper carriage connected to a respective half-drum of a drum.

Preferably, the above means for adjusting the translational movement of an upper carriage comprise at least one rotating screw connected to said upper carriage and motorized means adapted to impart a rotational movement to said at least one screw so as to adjust the advancement of said upper carriage and of the half-drum integral with it along the axis of rotation of the drums in approaching or distancing from the opposite half-drum.

In an embodiment, the above second vertical walls are movable along the direction of the axis of rotation of the drums distancing from or approaching each other so as to adjust the width of the receiving or forming chamber by an amount which is equal to the sum of the width of the circumferential surface of the drums and of the distance determined by the mutual positioning of the first half-drums and of the second half-drums along the direction of the axis of rotation.

In an embodiment, the above gas extraction device comprises a suction chamber internally arranged in each drum below the gas-permeable or perforated surfaces thereof, each suction chamber comprising a first half-chamber internally arranged in a first half-drum and a second half-chamber internally arranged in a second half-drum, the first half-chamber and the second half-chamber being movable along the axis of rotation between said first end-stroke position and said second end-stroke position of said first half-drum and of said second half-drum, a band being further provided, which overlaps at least one of said first half-chamber and said second half-chamber at opposite end portions of said half-chambers.

The features and advantages of the present invention will be more apparent from the following description given by way of indicative and non-limiting example with reference to the attached figures.

### BRIEF DESCRIPTION OF THE FIGURES

In the Figures:

FIG. 1 shows a perspective view of an apparatus for the continuous production of a mattress comprising agglomerated mineral fibres according to an embodiment of the invention;

FIG. 2 shows a schematic side view of the apparatus of FIG. 1 in an operating configuration in which the drums are in a position of maximum distance from each other;

FIG. 3 shows a schematic side view of the apparatus of FIG. 1 in an operating configuration in which the drums are in a position of maximum proximity to each other;

FIG. 4 shows a schematic side view of the apparatus of FIG. 1 in an operating configuration in which the drums are in an intermediate position between the positions of maximum proximity and maximum distance from each other;

FIG. 5 shows a schematic side view of the apparatus of FIG. 1 in an operating configuration with the fibre receiving or forming chamber having a smaller width;

FIG. 6 shows an enlarged view of a detail of the apparatus illustrated in FIG. 5;

FIG. 7 shows a schematic side view of the apparatus of FIG. 1 in an operating configuration with the fibre receiving or forming chamber having a greater width;

FIG. 8 shows an enlarged view of a detail of the apparatus illustrated in FIG. 7;

FIG. 9 shows an enlarged view of another detail of the apparatus illustrated in FIG. 7.

### DETAILED DESCRIPTION

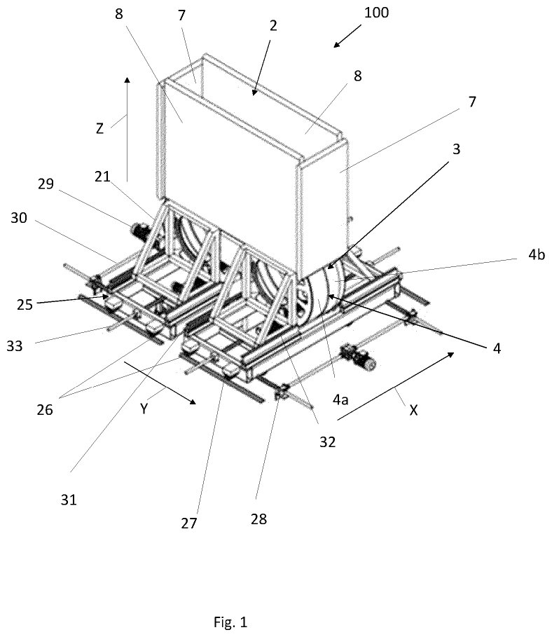

With reference to FIGS. 1-9, an apparatus according to the invention for the continuous production of a mattress comprising agglomerated mineral fibres is now described. Said apparatus is indicated with the reference number 100 as a whole.

The apparatus 100 comprises a fibre receiving or forming chamber 2, an accumulator conveyor 3 arranged below the fibre receiving or forming chamber 2 and comprising adjacent drums 4 movable in rotation around an axis of rotation X and provided with circumferential surfaces 5 equipped with holes 5a, a gas extraction device 6 having an output opening 11 arranged inside the drums 4 and in fluid communication with the perforated surfaces 5 of the drums 4 and a lower space 10 between the drums for unloading a mattress 14 comprising mineral fibres formed between the drums 4.

The receiving or forming chamber 2 comprises above first vertical walls 7 longitudinally extended in the direction of the axis of rotation X of the drums 4 and second vertical walls 8 transversally extended with respect the axis of rotation X of the drums 4, said first and second walls 7,8 delimiting above and laterally the receiving or forming chamber 2.

The first vertical walls 7 and the second vertical walls 8 of the receiving or forming chamber 2 consist of endlessly-movable rotating carpets or belts, whose outward-facing part is in contact with at least one scraping blade (not shown) which arranges to keep the surfaces of said walls clean from possible clots of fibres impregnated with the binder mixture which can form thereon.

In the present embodiment, the first vertical walls 7 and the second vertical walls 8 have the same direction of rotation, from top to bottom inside the receiving or forming chamber 2 and from bottom to top outside the receiving or forming chamber 2. Obviously, the first vertical walls 7 and the second vertical walls 8 can have an opposed direction of rotation.

The first vertical walls 7 end below in a tangential juxtaposition to the perforated circumferential surface 5 of one of the respective drums 4 while the second vertical walls 8 are laterally juxtaposed to the drums 4 at an upper area thereof above the output opening 11 of the gas extraction device 6 so as to laterally close a portion of the perforated circumferential surface 5 lying, during the rotation of the drums 4, above the lower space 10 which is present between the drums 4 for unloading the mattress 14.

In accordance with a first aspect of the present invention, the drums 4 are movable in translation distancing from or approaching each other along a displacement axis so as to adjust the distance between the two drums 4 according to the production requirements. In particular, the distance of said drums 4 is adjusted along said displacement axis Y, between a first end-stroke position, in which the drums 4 are in a position of maximum proximity to each other (minimum distance between the drums 4), and a second end-stroke position in which the drums 4 are in a position of maximum distance (maximum distance between the drums 4).

The movement along the axis Y of the drums 4 can be performed independently by respective sliding lower carriages 25 to which the drums 4 are integrally connected, means for adjusting the translational movement of each drum 4 being further provided. In greater detail, in the present embodiment, each lower carriage 25 is sliding along a pair of opposite tracks 26 and extended along said displacement axis Y by appropriate wheels 27 fixed to each lower carriage 25. Moreover, the means for adjusting the translational movement along the axis Y of each lower carriage 25 comprise a pair of opposite rotating screws 28 extended along the displacement axis Y and operatively connected to the lower carriage 25 of a respective drum 4 so as to adjust the advancement of said drum 4 along the axis Y in approaching or distancing from the opposite drum 4 depending on the rotation imparted to the screws 28. Said rotation can be imparted to the screws 28 by motorized means comprising a motor 29 connected to the rotating screws 28 by a motion transmission rod 30.

Advantageously, the distance between the drums 4 can be adjusted depending on the weight per square meter (weight/m²) of the mineral fibres in the mattress being formed or on the thickness of the mattress being formed between the drums 4 so as to exert an appropriate pressure on the fibres and obtain a mattress 14 of fibres having an optimum consistency, that is without said pressure being so excessive as to damage the mineral fibres or so insufficient as to affect the features of the final product, in particular the compactness of the final mattress.

For example, the distance between the drums 4 can be adjusted and varied based on the process parameters such as the weight per square meter of the mattresses which form on each drum 4 above the lower space 10 between the drums 4, on the amount of the binder used and on the size of the fibres, so as to obtain a final mattress 14 having desired rated specifications, in particular in terms of thickness and/or weight per square meter. In general, if the mattresses, formed on each drum 4 above the lower space 10 between the drums 4, have a low weight per square meter, the final thickness of the mattress 14 is given by the sum of the thickness of the mattresses formed on the drums 4. Differently, if the mattresses, formed on each drum 4 above the lower space 10 between the drums 4, have a high weight per square meter, the final thickness of the mattress 14 can be greater than the sum of the thickness of the mattresses formed on the drums 4, since the final mattress 14 can have elasticity features which involve an expansion, increasing the thickness. Accordingly, in order to obtain mattresses 14 being always compact and having an appropriate resistance, the distance of the drums 4 can be adjusted in the optimum manner by the person skilled in the art based on the above indications and on his general technical knowledge.

In the apparatus 100 according to the invention, the distance between the drums 4, understood as the (minimum) distance G between the circumferential surfaces 5 of the drums 4 can be comprised, for example, between 10 mm and 400 mm, preferably between 40 mm and 300 mm.

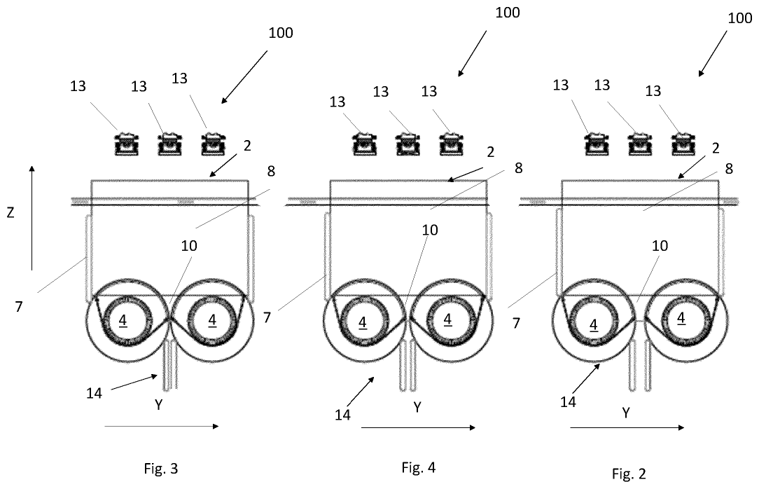

Some operating configurations of the apparatus 100 which differ in the adjustment of the mutual distance between the drums 4 and in the adjustment of the height of the first vertical walls 7 are shown in FIGS. 2-4.

In particular, a configuration of the apparatus 100 in which the drums 4 are at the maximum distance from each other in the end-stroke position of maximum distance is shown in FIG. 2. In order to keep the first lateral walls 7 tangentially juxtaposed to the drums 4, the first lateral walls 7 are raised along the vertical axis Z reaching a predefined maximum height which is a function of the end-stroke positions of maximum distance of the drums 4.

A configuration of the apparatus 100 in which the drums 4 are at the minimum distance from each other in the end-stroke position of maximum proximity is instead shown in FIG. 3. In order to keep the first lateral walls 7 tangentially juxtaposed to the drums 4, the first lateral walls 7 are lowered along the vertical axis Z reaching a predefined minimum height depending on the end-stroke positions of maximum proximity of the drums 4.

A configuration of the apparatus 100 in which the drums 4 are at a distance from each other in an intermediate position between the end-stroke position of maximum distance from each other and the end-stroke position of maximum proximity to each other is shown in FIG. 4. In order to keep the first lateral walls 7 tangentially juxtaposed to the drums 4, the first lateral walls 7 are adjusted along the vertical axis Z at an intermediate height between the above maximum one and minimum one depending on the intermediate mutual position of the drums 4.

Thus, in accordance with another aspect of the present invention, the first lateral walls 7 of the receiving or forming chamber 2 are vertically movable along an axis Z perpendicular to the axis of rotation X of the drums 4, i.e. in the direction of the height of the fibre receiving or forming chamber 2.

In particular, said movement of the first lateral walls 7 along the axis Z is preferably performed together with the translational movement of the drums 4 along the displacement axis Y so as to maintain the tangential juxtaposition of the lower end of the first lateral walls 7 to the perforated circumferential surface 5 of one of the respective drums 4, when the distance of the drums 4 along the displacement axis Y is varied. In other words, when the drums 4 are approached to each other, the first vertical walls 7 can be lowered in a synchronized manner or at a time after the movement of the drums 4 to such an extent as to ensure the tangential juxtaposition of the first vertical walls 7 to the perforated circumferential surface 5 of the respective drums 4 in the new position of proximity of said drums 4. Vice versa, when the drums 4 are spaced apart from each other, the first vertical walls 7 can be raised in a synchronized manner or at a time before the movement of the drums 4 to such an extent as to ensure the tangential juxtaposition of the first vertical walls 7 to the perforated circumferential surface 5 of the respective drums 4 in the new position of distance of said drums 4.

The variations in height of the first lateral walls 7 can be reduced enough so as not to bring significant changes in the volume of the receiving or forming chamber 2. For example, the variations in height of the first lateral walls 7 can be comprised between the 50 mm and 200 mm.

Advantageously, the vertical movement of the first lateral walls 7 and the translational movement along the axis Y of the drums 4 can be adjusted by a command and control unit (not shown) in electric communication (for example bidirectional) with the motorized means 29, 30 which control the translational movement of the drums 4 by means of the screws 28 and with motorized means (not shown) which control the vertical movement of the first vertical walls 7.

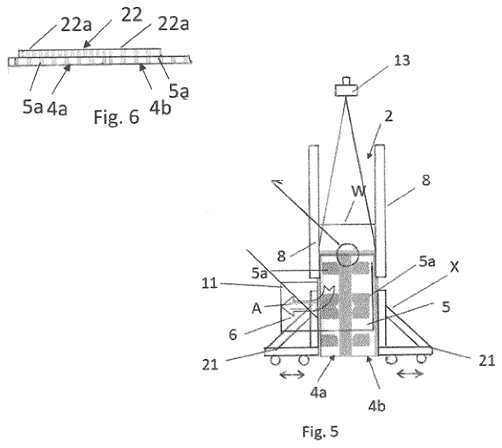

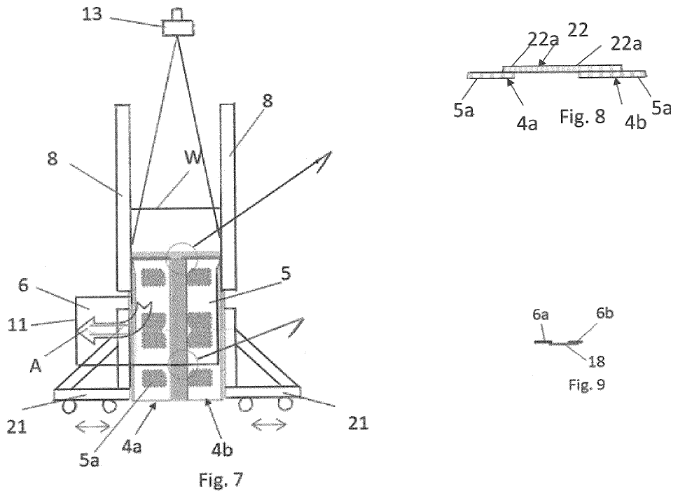

In accordance with another aspect of the present invention, the apparatus 100 also allows the width W of the receiving or forming chamber 2 to be adjusted and thus the width of the mattress 14 formed between the drums 4 to be adjusted. In this regard, in the present embodiment each drum 4 comprises a first half-drum 4a and a second half-drum 4b connected to each other (for example telescopically) and movable along the above axis of rotation X between a first end-stroke position in which the first half-drum 4a and the second half-drum 4b are juxtaposed or in contact with each other (FIGS. 5-6) and a second end-stroke position in which the first half-drum 4a and the second half-drum 4b are spaced apart from each other at a maximum distance along the direction of the axis of rotation X of the drums which is suitably predetermined depending on the desired maximum width W for the receiving or forming chamber 2 and hence for the final product (FIGS. 7 and 8).

Moreover, the second vertical walls 8 are movable outside the drums 4 along the direction of the axis of rotation X thereof distancing from or approaching each other so as to adjust the width W of the receiving or forming chamber 2 (i.e. the chamber dimension 2 in the direction of the axis of rotation X of the drums).

In greater detail, the movement of the second lateral walls 8 is preferably performed together with the translational movement of the first half-drums 4a and of the second half-drums 4b in the same direction along the direction of the axis of rotation X of the drums 4 so as to maintain the lateral juxtaposition of the second lateral walls 8 to the drums 4 and adjust the width W of the receiving or forming chamber 2 to a value which is substantially equal to the sum of the width of the circumferential surface of the drums 4 and of the distance determined by the mutual positioning of the first half-drums 4a and of the second half-drums 4b along the direction of the axis of rotation X of said drums 4.

The movement along the axis of rotation X of the half-drums 4a,4b of each 4 can be performed independently by respective sliding upper carriages 21 to which the first half-drum 4a or the second half-drum 4b are integrally connected, means for adjusting the translational movement of each one of the half-drums 4a, 4b being further provided. In greater detail, in the present embodiment, each upper carriage 21 connected to a first half-drum 4a or to a second half-drum 4b of a drum 4 is sliding along a pair of opposite guides 32 extended along the axis of rotation X of the drums 4 and fixed on each respective lower carriage 25. Moreover, the means for adjusting the translational movement along the axis X of each upper carriage 21 comprise a rotating screw 33 extended along the axis of rotation X and operatively connected to the upper carriage 21 of a respective first half-drum 4a or second half-drum 4b of a drum 4 so as to adjust the advancement of said first half-drum 4a or second half-drum 4b along the axis X in approaching or distancing from the opposite half-drum 4b or 4a depending on the rotation imparted to the screw 33. Said rotation can be imparted to the screw 33 by motorized means (not shown).

Advantageously, the movement of the second lateral walls 8 together with the translational movement of the drums 4 along the axis X can be adjusted by the command and control unit (not shown) as well, which is in that case in electric communication (for example bidirectional) with motorized means operatively connected to said second lateral walls 8 and said half-drums 4a,4b to control the movement thereof along the axis of rotation X.

The connection between the first half-drum 4a and the second half-drum 4b of each drum 4 can be performed in a conventional manner per se, for example the first half-drum 4a and the second half-drum 4b can be provided with coaxial tubular stems extended along the axis of rotation X of the drums 4 and sliding into each other so as to create a telescopic connection therebetween.

Moreover, in accordance with another aspect of the present invention, illustrated in FIGS. 5-8, the apparatus 100 comprises for each drum 4, a circumferentially-extending perforated plate 22 fixed on an end portion of the circumferential surface 5 of the second half-drum 4b and partially overlapped to an opposite end portion of the circumferential surface 5 of the first half-drum 4a.

Advantageously, the plate 22 allows the space which is created between the first half-drum 4a and the second half-drum 4b to be closed in any spacing position therebetween. In fact, the plate 22 has a width which is greater than the predetermined maximum distance between the first half-drum 4a and the second half-drum 4b along the direction of the axis of rotation X of the drums 4 in the end-stroke position of maximum distance of the half-drums 4a,4b so as to be always partially overlapped with a free end circumferential portion thereof to one of the half-drums 4a, 4b.

At the same time, the plate 22 being perforated with holes 22a having such dimensions as to hold the fibres and let gases pass (such as the holes 5a on the circumferential surface of the drums 4) allows the active surface of the drums 4 to be extended for accumulating the fibres where the first half-drum 4a and the second half-drum 4b are in a spaced-apart position from each other so as to suitably adjust the width W of the receiving or forming chamber 2 and accordingly the width of the final product unloaded from the apparatus 100.

In alternative embodiments of the apparatus 100 (not illustrated), the above-described plate 22 can be replaced by functionally equivalent means, for example by a perforated ring integrally formed at an end of one of the first half-drum 4a and the second half-drum 4b and having a greater diameter than the latter, the perforated ring being further partially overlapped to an opposite end portion of the circumferential surface 5 of the other of the first half-drum 4a and the second half-drum 4b.

Likewise, in the apparatus 100, the gas extraction device comprises a suction chamber 6 internally arranged in each drum 4 below the perforated circumferential surfaces 5 and each suction chamber comprises a first half-chamber internally arranged in a first half-drum 4a and a second half-chamber internally arranged in a second half-drum 4b. The first half-chamber and the second half-chamber are movable along the axis of rotation X between the first end-stroke position and the second end-stroke position of the first half-drum 4a and of the second half-drum 4b, and a band 18 is further provided, which overlaps the first half-chamber and the second half-chamber at opposite end portions thereof so as to close the space which is created between the first half-chamber and the second half-chamber in any spacing position therebetween and thereby allowing gases to be sucked in each above position.

In the present embodiment, the band 18 consists of a plate fixed on an external peripheral end portion of a wall 6b of the second half-chamber and partially overlapped to an opposite external peripheral end portion of a wall 6a of the first half-chamber. It is however possible to use other functionally equivalent means.

A configuration of the apparatus 100 in which the first half-drums 4a and the second half-drums 4b of the drums 4 are side by side (juxtaposed) with the second lateral walls 8 laterally juxtaposed to the half-drums 4a or to the second half-drums 4b of the drums 4 so as to define a minimum width W for the receiving or forming chamber 2 is shown in FIGS. 5 and 6. In this configuration, the portion of the circumferential plate 22 projecting from the second half-drum 4b towards the first half-drum 4a of each drum 4 is completely overlapped to a portion of the circumferential surface 5 of the first half-drum 4a and the width W of the fibre receiving or forming chamber 2 is substantially equal to the sum of the widths (or amplitudes) of the first half-drum 4a and of the second half-drum 4b of each drum 4 in the direction of the axis of rotation X of the drums 4. In this configuration, the two suction half-chambers of the suction device 6 of each drum 4 are also juxtaposed to each other being integral with the respective half-drums 4a and 4b and movable therewith.

A configuration of the apparatus 20 in which the first half-drums 4a and the second half-drums 4b of the drums 4 are spaced apart from each other with the second lateral walls 8 laterally juxtaposed to the half-drums 4a or the second half-drums 4b of the drums 4 so as to define a maximum width W for the fibre receiving or forming chamber 2 is instead shown in FIGS. 7-9. In this configuration, the portion of the circumferential plate 22 projecting from the second half-drum 4b towards the first half-drum 4a of each drum 4 is overlapped for a minimum free end circumferential part to the circumferential surface 5 of the first half-drum 4a so as to close the underlying space being created as a result of the mutual distance of the first half-drums 4a and the second half-drums 4b of the drums 4. A width W is thereby defined for the fibre receiving or forming chamber 2 which is substantially equal to the sum of the widths (or amplitudes) of the first half-drum 4a and the second half-drum 4b of each drum 4 and of the predefined maximum distance between the first half-drums 4a and the second half-drums 4b in the direction of the axis of rotation X of the drums. In this configuration, the two suction half-chambers of the suction device 6 of each drum 4 are also spaced apart from each other in the same manner being integral with the respective half-drums 4a and 4b and movable therewith and the band 18 is overlapped to free end peripheral portions of the wall 6a of the first half-chamber and of the wall 6b of the second half-chamber so as to close the space being created therebetween as a result of the mutual distance of the first half-drums 4a and of the second half-drums 4b.

Obviously, the features described above for the apparatus 100 also allow the width W for the receiving or forming chamber 2 to be adjusted to intermediate values between the minimum width and the maximum width by suitably adjusting the mutual position (distance) of the first half-drums 4a and of the second half-drums 4b in intermediate positions between the juxtaposition end-stroke of the first half-drums 4a and of the second half-drums 4b and the end-stroke of maximum distance (spacing) between the first half-drums 4a and the second half-drums 4b.

It should be noted that the plate 22 or other functionally equivalent means can be advantageously formed with a reduced thickness so as to reduce the height of the step created by the presence of the plate 22 on the circumferential surface 5 of the drums 4 and keep possible inhomogeneities in the thickness of the final product within values which are acceptable or anyhow such as not to jeopardize the desired features for the final product.

In this regard, the plate 22 can be formed with a thin thickness preferably comprised between 1 mm and 5 mm, in particular about 3 mm.

Moreover, advantageously, the perforated plate 22 has a ratio between the solid part and the empty part (holes 22a) which is greater than that between the solid part and the empty part (holes 5a) of the half-drums 4a and 4b in the area overlapping the circumferential surface of the first half-drum 4a with holes 22a having dimensions which are smaller than the dimensions of the holes 5a of the half-drums 4a and 4b. In other words, in the area overlapping the circumferential surface of the first half-drum 4a, the plate 22 has a greater number of holes 22a with respect to the underlying holes 5a which are present in the half-drum 4a.

Advantageously, this allows the loss of active surface for sucking gases on the drums 4 during the operation of the apparatus 20 to be reduced to a minimum because of the possible overlapping of solid parts of the overlapping plate 22 on the underlying holes 5a of the drums 4, especially in case of loss or imperfect synchrony of the rotational movement of said drums 4.

Concerning the operation of the above-described apparatus 100, in a first phase the distance between the drums shall be adjusted depending on the weight per square meter of the mattress which forms on each drum 4 above the lower space 10 between the drums 4 so as to obtain a final product (mattress) with desired features, particularly in terms of thickness and/or weight per square meter. Usually, the final mattresses are obtained with a weight per square meter comprised between 400 g/m² and 5000 g/m² according to the kind of final product (mattress), for example in the form of rolls or panels. The distance between the drums 4, can be adjusted depending on the type of final product as well, for example panels or rolls, (besides on the weight per square meter), so as not to affect the elasticity features of the final product, in particular when it has a high value of the weight per square meter. For example, if the final mattress is roll-shaped and, moreover, it has a high value of the weight per square meter, a too high pressure must not be applied during the coupling phase, since this would damage the final mattress 14, compacting it too much, thereby affecting the important elasticity features. Therefore, for the same weight per square meter, final products in the form of rolls or panels may require coupling distances between the drums 4 which are different from each other.

Thus, the fibres impregnated with the binder mixture, gases and induced air outputted from respective fiberization units 13 are introduced in the receiving or forming chamber 2 and directed towards the perforated circumferential surfaces 5 of the drums 4, which are rotated in opposed directions. The fibres accumulate on the circumferential surfaces 5 of the drums 4 forming a mattress 14 comprising agglomerated fibres while gases pass through the holes 5a of the circumferential surfaces 5, suitably sucked by the extraction device 6, for example a device which is able to create a vacuum, to be released outside (arrow A) the output opening 11. In fact, it should be noted that the dimensions of the holes 5a of the circumferential surfaces 5 are reduced enough to allow gases to pass but not fibres to pass.

The mattress 14, carried by the rotational movement of the drums 4, is thus conveyed towards the lower space 10 between the drums 4 where it is unloaded and collected on a conveyor belt 16 to be sent to next treatment stations, storage or other uses.

In view of the above, the apparatus according to the present invention reaches the predetermined objects and achieves important advantages with respect to known apparatuses.

In fact, due to the adoption of movable drums sliding along the displacement axis Y, perpendicular to the axis of rotation X thereof, the apparatus according to the invention allows the thickness of the mattress of fibres coming from the fiberization machines to be effectively adjusted according to the production requirements and based on the value of the weight per square meter of the mineral fibres in the mattress being formed, all of this without damaging the fibres and without obtaining a not very compact product. This can be performed in a simple manner by suitably adjusting the mutual position (distance) between the drums.

In particular, when the value of the weight per square meter of the mineral fibres is high, the distance between the drums is increased so as to reduce the compression pressure of the fibres, so as to avoid possible breaks.

On the contrary, when the value of the weight per square meter of the mattress of mineral fibres is very low, the distance between the drums is decreased so as to increase the pressure, so as to obtain compact and non-inhomogeneous mattresses of mineral fibres.

Accordingly, due to said apparatus, the distances between the drums can be adjusted so as to be able to adjust the pressure provided by the drums during the formation of the mattress of mineral fibres and thus to adjust the thickness thereof.

In fact, due to the adoption of movable drums consisting of two half-drums sliding along the axis of rotation thereof (and due to the adoption of an overlapping band between the half-drums, the apparatus according to the invention allows to effectively adjust the width of the receiving or forming chamber of the fibres coming from the fiberization machines according to the requirements and accordingly the width of the product unloaded from the apparatus within wide ranges according to the most varied production requirements. This can be performed in a simple manner by suitably adjusting the mutual position (distance) between the half-drums composing the drums and arranging to laterally juxtapose to the drums the vertical walls of the chute longitudinally extending in the transversal direction to the axis of rotation of the drums.

Finally, it should be noted that the creation of movable drums perpendicularly sliding along the axis of rotation thereof and in the form of half-drums sliding along the axis of rotation of the drums and equipped with an overlapping plate does not involve significant complications of structural, functional and/or construction nature of the apparatus.

A person skilled in the art will be allowed to bring several modifications and alternatives to the apparatus according to the invention, all however falling within the scope of protection of the attached claims.

1. An apparatus for the continuous production of a mattress comprising agglomerated mineral fibres comprising a mineral fibre receiving or forming chamber, an accumulator conveyor arranged below the receiving or forming chamber and comprising adjacent drums provided with perforated or gas-permeable circumferential surfaces for receiving and accumulating the fibres to form a mattress comprising mineral fibres between the drums, a gas extraction device in fluid communication with the perforated or gas-permeable circumferential surfaces of the drums and a lower space between the drums for unloading the mattress comprising mineral fibres formed between the drums, wherein the drums are movable along a displacement axis perpendicular to an axis of rotation of the drums between a first end-stroke position in which the drums are in a position of maximum distance from each other and a second end-stroke position in which the drums are in a position of maximum proximity to each other.

2. The apparatus according to claim 1, wherein the fibre receiving or forming chamber comprises first vertical walls longitudinally extended in the direction of the axis of rotation of the drums and ending each below in a tangential juxtaposition to the perforated or gas-permeable circumferential surfaces of a respective drum, and second vertical walls transversally extended with respect to the axis of rotation of the drums and ending each below in a lateral juxtaposition to a respective drum.

3. The apparatus according to claim 1, further comprising lower carriages sliding along the displacement axis to which respective drums are integrally connected, and means for adjusting the translational movement along the displacement axis of each lower carriage connected to a respective drum.

4. The apparatus according to claim 3, wherein the means for adjusting the translational movement of a lower carriage comprise at least one rotating screw connected to said lower carriage and motorized means adapted to impart a rotational movement to said at least one screw so as to adjust the advancement of said lower carriage and of the drum integral with it along the displacement axis in approaching or distancing from the opposite drum.

5. The apparatus according to claim 1, wherein the distance between the perforated or gas-permeable circumferential surfaces of the drums between the position of maximum proximity and the position of maximum distance thereof is comprised between 10 mm and 400 mm.

6. The apparatus according to claim 1, wherein the first vertical walls of the receiving or forming chamber are movable in the direction of the height of the fibre receiving or forming chamber along a vertical axis perpendicular to the axis of rotation of the drums, so as to maintain the tangential juxtaposition of the lower end of the first vertical walls to the perforated or gas-permeable circumferential surface of one of the respective drums, depending on the mutual positioning of the drums along the displacement axis.

7. The apparatus according to claim 1, wherein the drums comprise each a first half-drum and a second half-drum telescopically connected to each other and movable along the axis of rotation between a first end-stroke position in which the first half-drum and the second half-drum are juxtaposed or in contact with each other, and a second end-stroke position in which the first half-drum and the second half-drum are spaced apart from each other at a predetermined maximum distance along the direction of the axis of rotation of the drums, wherein a gas-permeable or perforated circumferential band is further provided, wherein the gas-permeable or perforated circumferential band overlaps at least one of the first half-drum and the second half-drum at opposite end portions of said half-drums.

8. The apparatus according to claim 7, further comprising upper carriages sliding along said axis of rotation (X) to which respective half-drums of a drum are integrally connected, wherein each upper carriage is slidable along a pair of opposite guides extended along the axis of rotation of the drums and fixed on a respective lower carriage, and further comprising means for adjusting the translational movement along the axis of rotation of each upper carriage connected to a respective half-drum of a drum.

9. The apparatus according to claim 8, wherein the means for adjusting the translational movement of an upper carriage comprise at least one rotating screw connected to said upper carriage and motorized means adapted to impart a rotational movement to said at least one screw so as to adjust the advancement of said upper carriage and of the half-drum integral with it along the axis of rotation (X) in approaching or distancing from the opposite half-drum.

10. The apparatus according to claim 7, wherein the second vertical walls are movable along the direction of the axis of rotation of the drums distancing from or approaching each other so as to adjust the width of the receiving or forming chamber by an amount which is equal to the sum of the width of the perforated or gas-permeable circumferential surface of the drums and of the distance determined by the mutual positioning of the first half-drums and of the second half-drums along the direction of the axis of rotation.

11. The apparatus according to claim 7, wherein the gas extraction device comprises a suction chamber internally arranged in each drum below the gas-permeable or perforated circumferential surfaces thereof, wherein each suction chamber comprises a first half-chamber internally arranged in a first half-drum and a second half-chamber internally arranged in a second half-drum, wherein the first half-chamber and the second half-chamber are movable along the axis of rotation between said first end-stroke position and said second end-stroke position of said first half-drum and of said second half-drum, wherein a band is further provided, wherein the band overlaps at least one of said first half-chamber and said second half-chamber at opposite end portions of said half-chambers.

12. The apparatus according to claim 5, wherein the distance between the perforated or gas-permeable circumferential surfaces of the drums between the position of maximum proximity and the position of maximum distance thereof is comprised between 40 mm and 300 mm.
